(19) United States
(12) Patent Application Publication
(10) Pub. No.: US 2020/0379333 A1
(43) Pub. Date: Dec. 3, 2020

(54) PROJECTION-TYPE DISPLAY APPARATUS

(71) Applicant: SEIKO EPSON CORPORATION, Tokyo (JP)

(72) Inventors: Hiroaki MIYA, Matsumoto-shi (JP); Tomohiro TAKAGI, Azumino-shi (JP); Kanji YOSHIDA, Azumino-shi (JP); Masashi KATO, Matsumoto-shi (JP)

(73) Assignee: SEIKO EPSON CORPORATION, Tokyo (JP)

(21) Appl. No.: 16/884,230

(22) Filed: May 27, 2020

(30) Foreign Application Priority Data
May 28, 2019 (JP) 2019-099124

(51) Int. Cl. G03B 21/20; H04N 9/31; G02B 27/10; G02B 27/14

(52) U.S. Cl. CPC G03B 21/2066; H04N 9/3158; G02B 27/141; H04N 9/3105; G02B 27/1053; H04N 9/3155

(57) ABSTRACT

A projection-type display apparatus includes a light source apparatus, a first optical system with a superimposing lens receiving illumination light from the source apparatus, a second optical system including a first color separator downstream the superimposing lens, mirror, and field lens, and an optical enclosure accommodating the second system. The first separator reflects, toward the mirror, first light in the illumination light belonging to a first wavelength band, and transmits light belonging to a wavelength band excluding the first wavelength band. The mirror reflects, toward the field lens, the first light reflected by the first separator. An angle between an optical axis of the superimposing lens and the first separator is greater than 45° in a first system plan view. A field lens optical axis is substantially parallel to a first system optical axis. The optical enclosure includes a fixing section holding and fixing the first separator.

The present application is based on, and claims priority from JP Application Serial Number 2019-099124, filed May 28, 2019, the disclosure of which is hereby incorporated by reference herein in its entirety.

### BACKGROUND

### 1. Technical Field

The present disclosure relates to a projection-type display apparatus.

### 2. Related Art

There has been a known projector including a color separation system that separates white light outputted from a light source into a plurality of color light fluxes and causes the color light fluxes to be incident on corresponding light modulators. The color separation system uses a dichroic mirror for separating the white light from the light source into a plurality of color light fluxes. The dichroic mirror is disposed in a position closest to the light source among the components that form the color separation system. For example, the dichroic mirror reflects a first light component, such as red light, and transmits the other color components. The first light component reflected off the dichroic mirror is reflected again off a reflection mirror provided in the optical path, then caused by a field lens to converge toward a light modulator that modulates the first light component.

In this process, the optical axis of the light source is so set as to be substantially parallel to the optical axis of the field lens. To achieve the arrangement described above, the angle between the optical axis of the light source and the dichroic mirror, which is disposed in a position closest to an illumination system among the components that form the color separation system, is typically set at 45°.

JP-A-2004-317951 discloses a video display apparatus in which a dichroic mirror disposed in a position closest to a light source has a color separation surface that inclines with respect to the optical axis of the light source by a variable angle.

The video display apparatus described in JP-A-2004-317951, however, has a problem of a difficulty in reducing the size of the apparatus. In detail, the video display apparatus includes a pair of holders that hold the dichroic mirror. One of the pair of holders has three grooves for the inclination adjustment that allow the inclination angle of the color separation surface of the dichroic mirror to be variable, that is, the angle between the optical axis of an illumination system and the dichroic mirror to be variable. It is therefore necessary to provide a space that accommodates the holder having the grooves described above. The space makes it difficult to allow the dichroic mirror to be close to a light collection lens adjacent to the dichroic mirror, resulting in a difficulty in reducing the size of the apparatus. That is, a projection-type display apparatus that readily allows size reduction as compared with a projection-type display apparatus in related art, such as a video display apparatus, has been desired.

### SUMMARY

A projection-type display apparatus according to the present application includes a light source apparatus, a first optical system that includes a superimposing lens and that illumination light outputted from the light source apparatus enters, a second optical system including a first color separator, a mirror, and a field lens, and an optical enclosure that accommodates the second optical system. The first color separator is disposed on a downstream of the superimposing lens, reflects first light that is contained in the illumination light that exits out of the first optical system and belongs to a first wavelength band toward the mirror, and transmits light that belongs to a wavelength band excluding the first wavelength band. The mirror reflects the first light reflected off the first color separator toward the field lens. An angle between an optical axis of the superimposing lens and the first color separator is greater than 45° in a plan view of the first optical system. An optical axis of the field lens is substantially parallel to an optical axis of the first optical system. The optical enclosure includes a fixing section that holds and fixes the first color separator.

In the projection-type display apparatus described above, the first color separator and the mirror may be so disposed as to be substantially parallel to each other.

The projection-type display apparatus described above may further include a movable section that adjusts orientation of the mirror with respect to the optical axis of the field lens.

In the projection-type display apparatus described above, the second optical system may include a second color separator that receives the light that belongs to a wavelength band excluding the first wavelength band, reflects second light that belongs to a second wavelength band, and transmits third light that belongs to a wavelength band excluding the second wavelength band.

The projection-type display apparatus described above may further include a first modulator that modulates the first light, a second modulator that modulates the second light, a third modulator that modulates the third light, and a color combiner that combines the modulated color light fluxes with one another.

### BRIEF DESCRIPTION OF THE DRAWINGS

FIG. 1 is a perspective view showing the exterior appearance of a projector according to an embodiment.

FIG. 2 is a diagrammatic view showing the internal configuration of the projector.

FIG. 3 is a diagrammatic view showing the configuration of a light source apparatus.

FIG. 4 is a diagrammatic view showing the detailed arrangement of a dichroic mirror, a superimposing lens, and other components.

FIG. 5 is a plan view showing the arrangement of the dichroic mirror and fixing sections.

FIG. 6 is a plan view showing the exterior appearance of a movable section for moving a reflection mirror.

### DESCRIPTION OF EXEMPLARY EMBODIMENTS

An embodiment of the present disclosure will be described below with reference to the drawings. The embodiment described below is an example of the present disclosure. The present disclosure is not limited to the following embodiment and also encompasses a variety of variations implemented to the extent that the variations do not change the substance of the present disclosure. Each member in the following drawings is so drawn at a scale different from an actual scale as to be large enough to be recognizable.

### 1. Embodiment

### 1.1 Configuration of Projector

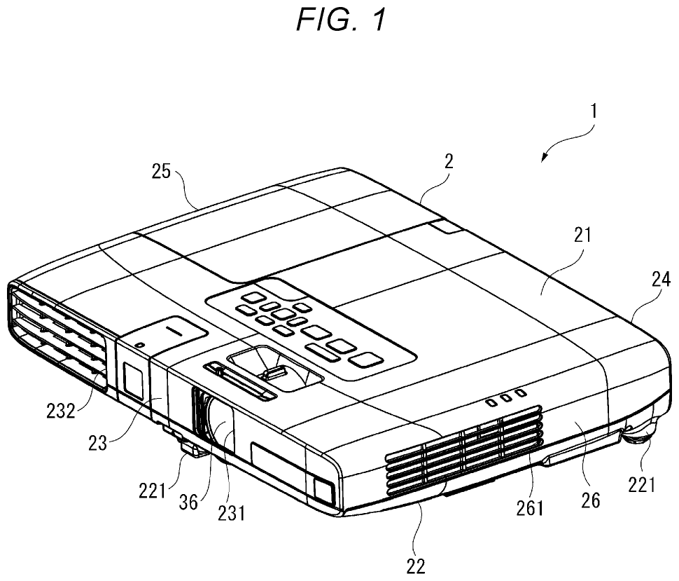

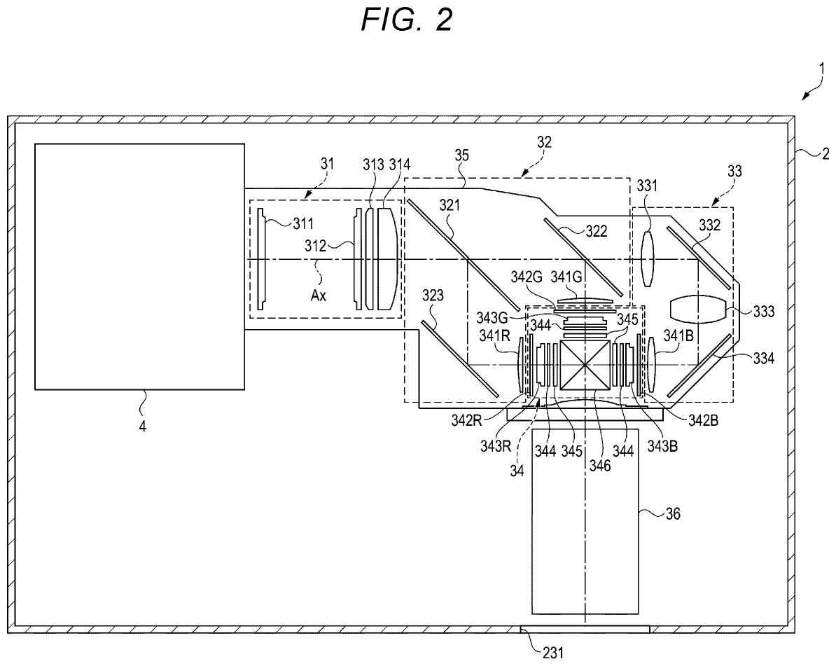

In the present embodiment, a projector including three liquid crystal devices, which are each a light modulator, is presented as a projection-type display apparatus by way of example. The configuration of the projector as the projection-type display apparatus will first be described with reference to FIGS. 1 and 2. FIG. 1 is a perspective view showing the exterior appearance of the projector according to the embodiment. FIG. 2 is a diagrammatic view showing the internal configuration of the projector.

The projector 1 according to the present embodiment is a projection-type image display apparatus that modulates light outputted from a light source apparatus that will be described later to form an image according to image information and enlarges and projects the formed image on a projection receiving surface, such as a screen.

The projector 1 includes an exterior enclosure 2, which forms the exterior of the projector 1, as shown in FIG. 1. The exterior enclosure 2 has a substantially box-like shape and includes a top surface section 21, a bottom surface section 22, a front surface section 23, a rear surface section 24, a left side surface section 25, and a right side surface section 26.

The bottom surface section 22 includes a plurality of legs 221, which are in contact with an installation surface on which the projector 1 is placed. The front surface section 23 is located on a side of the exterior enclosure 2 that is the side facing a projected image. The front surface section 23 has an opening 231, via which part of a projection optical apparatus 36 is exposed. An image is projected from the projection optical apparatus 36 via the opening 231. The front surface section 23 is provided with an exhaust port 232. A cooling gas having cooled a cooling target in the projector 1 is exhausted out of the exterior enclosure 2 via the exhaust port 232. The right side surface section 26 is provided with an introduction port 261. A gas, such as the air outside the exterior enclosure 2, is introduced as the cooling gas into the exterior enclosure 2 via the introduction port 261.

The projector 1 includes the following components in the exterior enclosure 2: a light source apparatus 4; a homogenizing apparatus 31 as a first optical system; a color separation apparatus 32 as a second optical system; a relay apparatus 33; an image formation apparatus 34; an optical enclosure 35; and a projection optical apparatus 36, as shown in FIG. 2. The light source apparatus 4 outputs illumination light. The configuration of the light source apparatus 4 will be described later. In FIG. 2, the exhaust port 232, the introduction port 261, and other components are omitted. Although not shown, the projector further includes a controller that controls the operation of the projector, a power supply that supplies electronic parts of the projector 1 with electric power, and a cooler that cools the light source apparatus 4 and other components.

The homogenizing apparatus 31 is disposed in a position to which the illumination light outputted from the light source apparatus 4 travels. The illumination light outputted from the light source apparatus 4 enters the homogenizing apparatus 31. The homogenizing apparatus 31 includes a first multi-lens array 311, a second multi-lens array 312, a polarization converter 313, and a superimposing lens 314. The components described above are arranged in the order described above toward the side to which the illumination light outputted from the light source apparatus 4 travels. The homogenizing apparatus 31 homogenizes the illumination light outputted from the light source apparatus 4. The homogenized illumination light exits out of the homogenizing apparatus 31, travels via the color separation apparatus 32 and the relay apparatus 33, and enters the image formation apparatus 34, and a modulation area of each of light modulators 343R, 343G, and 343B, which will be described later, is illuminated with the illumination light.

The color separation apparatus 32 is disposed in a position to which the illumination light having exited out of the homogenizing apparatus 31 travels. That is, the illumination light having exited out of the homogenizing apparatus 31 enters the color separation apparatus 32. The color separation apparatus 32 includes a dichroic mirror 321 as a first color separator, a dichroic mirror 322 as a second color separator, a reflection mirror 323 as a mirror, and field lenses 341R and 341G.

The color separation apparatus 32 separates the light incident from the homogenizing apparatus 31 into color light fluxes. The illumination light having entered the color separation apparatus 32 reaches the dichroic mirror 321. The dichroic mirror 321 is so disposed as to be adjacent to the superimposing lens 314 in the homogenizing apparatus 31.

The dichroic mirror 321 reflects first light, which is contained in the illumination light having exited out of the homogenizing apparatus 31 and belongs to a first wavelength band, toward the reflection mirror 323 and transmits light that belongs to the wavelength band excluding the first wavelength band. The first wavelength band is, for example, a wavelength band corresponding to a red light region, and the wavelength band excluding the first wavelength band is a wavelength band corresponding to a green light region and a red light region. The wavelength band corresponding to the red light region is not limited to a specific wavelength band and ranges, for example, from about 610 nm to 750 nm. The wavelength band corresponding to the blue light region is not limited to a specific wavelength band and ranges, for example, from about 430 nm to 495 nm. The wavelength band corresponding to the green light region is not limited to a specific wavelength band and ranges, for example, from about 495 nm to 570 nm. That is, the first light is, for example, red light, and the light that belongs to the wavelength band excluding the first wavelength band is green light and blue light. The red light is substantially red light, the green light is substantially green light, and the blue light is substantially blue light. The first wavelength band does not necessarily correspond to the red light region and may correspond to the green or blue light region, and the first light may be green or blue light correspondingly.

The reflection mirror 323 is disposed in a position to which the red light that is the first light and has been reflected off the dichroic mirror 321 travels. The reflection mirror 323 reflects the red light reflected off the dichroic mirror 321 toward the field lens 341R. The field lens 341R causes the red light incident thereon to converge and travel toward the light modulator 343R. The arrangement of the superimposing lens 314, the dichroic mirror 321, the reflection mirror 323, and other components will be described later in detail.

The dichroic mirror 322 is disposed in a position to which the green light and the blue light having passed through the dichroic mirror 321 travels. The dichroic mirror 322 receives the green light and the blue light described above, reflects second light that belongs to a second wavelength band, and transmits third light that belongs to a wavelength band excluding the second wavelength band. The second wavelength band, for example, corresponds to the green light region. That is, the second light is, for example, the green light, and the third light is, for example, the blue light. The second wavelength band does not necessarily correspond to the green light region and may correspond to the blue light region. That is, the second light may be the blue light, and the third light may be the green light.

The field lens 341G is disposed in a position to which the green light that is the second light and has been reflected off the dichroic mirror 322 travels. The field lens 341G causes the green light incident thereon to converge and travel toward a light-incident-side polarizer 342G in the image formation apparatus 34.

The relay apparatus 33 is disposed in a position to which the blue light that is the third light and has passed through the dichroic mirror 322 travels. The blue light described above enters the relay apparatus 33. The relay apparatus 33 includes a light-incident-side lens 331, a first reflection mirror 332, a relay lens 333, a second reflection mirror 334, and a light-exiting-side lens 341B, which is a field lens.

The blue light has an optical path longer than those of the red light and the green light and therefore tends to have a wide light flux. The relay lens 333 therefore prevents the light flux from spreading. The blue light having entered the relay apparatus 33 enters the light-incident-side lens 331, which causes the blue light to converge, and the convergent blue light is reflected off the first reflection mirror 332 and is focused in the vicinity of the relay lens 333. The blue light having entered the relay lens 333 then diverges toward the second reflection mirror 334 and the light-exiting-side lens 341B.

The second reflection mirror 334 reflects the blue light having exited out of the relay lens 333 and causes the blue light to enter the light-exiting-side lens 341B. The light-exiting-side lens 341B causes the blue light incident thereon to converge and travel toward a light-incident-side polarizer 342B in the image formation apparatus 34.

The dichroic mirrors 321 and 322 described above are each manufactured by forming a dielectric multilayer film formed of a plurality of layers each corresponding to a certain function on a transparent glass plate. The wavelength of the light that passes through each of the dichroic mirrors 321 and 322 changes in accordance with the thickness of the dielectric multilayer film. The dichroic mirror 321 is therefore so configured that the thickness of the dielectric multilayer film is adjusted as appropriate in accordance with an angle θ1 between the optical axis of the superimposing lens 314, which will be described later, and the light incident surface of the dichroic mirror 321.

The image formation apparatus 34 includes light-incident-side polarizers 342R, 342G, and 342B, the light modulators 343R, 343G, and 343B, and three viewing angle compensators 344, three light-exiting-side polarizers 345, and a color combining apparatus 346. The light modulator 343R is a first light modulator and modulates the red light, which is the first light. The light modulator 343G is a second light modulator and modulates the green light, which is the second light. The light modulator 343B is a third light modulator and modulates the blue light, which is the third light. The color combining apparatus 346 is a color combiner and combines the red, green, and blue modulated light fluxes modulated by the light modulators 343R, 343G, and 343B.

The light modulators 343R, 343G, and 343B modulate the light outputted from the light source apparatus 4 in accordance with image information. In the present embodiment, the light modulators 343R, 343G, and 343B are each a transmissive liquid crystal panel, and the light-incident-side polarizers 342R, 342G, and 342B, the light modulators 343R, 343G, and 343B, and the light-exiting-side polarizers 345 form light crystal light valves. The light modulators 343R, 343G, and 343B are not each limited to a transmissive liquid crystal panel and may each, for example, be a reflective liquid crystal panel.

The light combining apparatus 346 combines the modulated light fluxes modulated by the light modulators 343R, 343G, and 343B with one another to form an image and causes the image to enter the projection optical apparatus 36. In the present embodiment, the color combining apparatus 346 is a cross dichroic mirror but not limited thereto. The color combining apparatus 346 may be formed, for example, of a plurality of dichroic mirrors.

The optical enclosure 35 accommodates the homogenizing apparatus 31, the color separation apparatus 32, the relay apparatus 33, and the image formation apparatus 34. An illumination optical axis Ax, which is the optical axis of the homogenizing apparatus 31, is set in the projector 1. The optical enclosure 35 holds the apparatuses 31 to 34 described above in predetermined positions along the illumination optical axis Ax. The light source apparatus 4 and the projection optical apparatus 36 are also disposed in predetermined positions in the illumination optical axis Ax.

The projection optical apparatus 36 enlarges and projects the image incident from the image formation apparatus 34 on the projection receiving surface that is not shown. That is, the projection optical apparatus 36 projects the modulated light fluxes modulated by the light modulators 343R, 343G, and 343B. The projection optical apparatus 36 is formed of a lens unit including a plurality of lenses accommodated in a tubular lens barrel.

### 1.2 Configuration of Light Source Apparatus

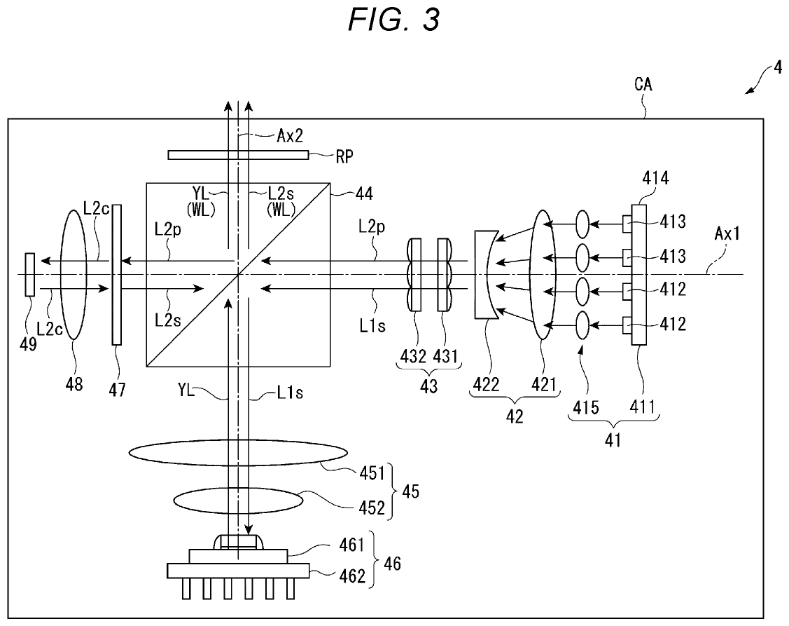

The configuration of the light source apparatus 4 will next be described with reference to FIG. 3. FIG. 3 is a diagrammatic view showing the configuration of the light source apparatus. The light source apparatus 4 outputs the illumination light to the homogenizing apparatus 31.

The light source apparatus 4 includes a light source enclosure CA and the following components accommodated in the light source enclosure CA: a light source section 41, an afocal optical element 42, a homogenizer optical element 43, a polarization separator 44, a first light collector 45, a wavelength converter 46, a first retardation element 47, a second light collector 48, a diffusive reflector 49, and a second retardation element RP, as shown in FIG. 3. The light source enclosure CA is a sealed enclosure that dirt, dust, and other contaminants are unlikely to enter.

The light source section 41, the afocal optical element 42, the homogenizer optical element 43, the polarization separator 44, the first retardation element 47, the second light collector 48, and the diffusive reflector 49 are arranged along an illumination optical axis Ax1 set in the light source apparatus 4. The wavelength converter 46, the first light collector 45, the polarization separator 44, and the second retardation element RP are arranged along an illumination optical axis Ax2, which is perpendicular to the illumination optical axis Ax1 and set in the light source apparatus 4. The illumination optical axis Ax2 set in the light source apparatus 4 and the illumination optical axis Ax1 set in the projector 1 do not necessarily coincide with each other.

The light source section 41 includes a light source 411, which outputs light, and a collimator lens 415. The light source 411 includes a plurality of first semiconductor lasers 412 and a plurality of second semiconductor lasers 413, and a support member 414. The first semiconductor lasers 412 output s-polarized blue light L1s, which is excitation light. The blue light L1s is, for example, laser light having a peak wavelength of 440 nm. The blue light L1s outputted from the first semiconductor lasers 412 enters the wavelength converter 46. The second semiconductor lasers 413 output p-polarized blue light L2p. The blue light L2p is, for example, laser light having a peak wavelength of 460 nm. The blue light L2p outputted from the second semiconductor lasers 413 enters the diffusive reflector 49.

The support member 414 supports the plurality of first semiconductor lasers 412 and the plurality of second semiconductor lasers 413 arranged in arrays in a plane perpendicular to the illumination optical axis Ax1. The support member 414 is made of a metal having thermal conductivity. The support member 414 may be coupled to the cooler that is not shown to cool the light source 411.

The blue light L1s outputted from the first semiconductor lasers 412 and the blue light L2p outputted from the second semiconductor lasers 413 are each converted by the collimator lens 415 into a parallel light flux, which enters the afocal optical element 42. In the present embodiment, the light source 411 is configured to output the s-polarized blue light L1s and the p-polarized blue light L2p, but not necessarily. The light source 411 may instead be configured to output blue light that is linearly polarized light having a fixed polarization direction. In this case, a retardation element that converts the linearly polarized light of one type incident thereon into light containing s-polarized light and p-polarized light may be disposed between the light source section 41 and the polarization separator 44.

The afocal optical element 42 adjusts the light flux diameters of the blue light L1s and the blue light L2p incident from the light source section 41 and causes the adjusted blue light L1s and blue light L2p to enter the homogenizer optical element 43. The afocal optical element 42 is formed of a lens 421, which causes light incident thereon to converge, and a lens 422, which parallelizes the convergent light flux from the lens 421. The homogenizer optical element 43 homogenizes the illuminance distribution of each of the blue light L1s and the blue light L2p. The homogenizer optical element 43 is formed of a pair of multi-lens arrays 431 and 432. The blue light L1s and the blue light L2p having passed through the homogenizer optical element 43 enter the polarization separator 44.

The polarization separator 44 is a prism-shaped polarization beam splitter and separates the s-polarized component and the p-polarized component contained in the light incident thereon from each other. Specifically, the polarization separator 44 reflects the s-polarized component and transmits the p-polarized component. The polarization separator 44 has a color separation characteristic that causes light having wavelengths longer than or equal to a predetermined wavelength to pass through the polarization separator 44 irrespective of the polarization of the light, the s-polarized component or the p-polarized component. The s-polarized blue light L1s is therefore reflected off the polarization separator 44 and enters the first light collector 45. On the other hand, the p-polarized blue light L2p passes through the polarization separator 44 and enters the first retardation element 47.

The first light collector 45 causes the blue light L1s reflected off the polarization separator 44 to converge and travel to the wavelength converter 46. The first light collector 45 parallelizes fluorescence YL incident from the wavelength converter 46. In the present embodiment, the first light collector 45 is formed of two lenses 451 and 452 but not necessarily.

The wavelength converter 46 is excited with the blue light L1s incident thereon to produce the fluorescence YL having wavelengths longer than the wavelength of the blue light L1s and causes the fluorescence YL to exit toward the first light collector 45. In other words, the wavelength converter 46 converts the light incident thereon in terms of wavelength and outputs the converted light. The fluorescence YL produced by the wavelength converter 46 is light having a peak wavelength ranging, for example, from 500 nm to 700 nm. The wavelength converter 46 includes a wavelength conversion section 461 and a heat dissipation section 462.

The wavelength conversion section 461 has a wavelength conversion layer and a reflection layer although not shown. The wavelength conversion layer contains a phosphor that converts the incident blue light L1s in terms of wavelength into the fluorescence YL, which is non-polarized light, and diffusively outputs the fluorescence YL. The reflection layer reflects the fluorescence YL incident from the wavelength conversion layer toward the first light collector 45. The heat dissipation section 462 is provided on a surface of the wavelength conversion section 461 that is the surface opposite the light incident side and dissipates heat generated by the wavelength conversion section 461.

The fluorescence YL outputted from the wavelength converter 46 passes through the first light collector 45 along the illumination optical axis Ax2 and then enters the polarization separator 44 having the color separation characteristic described above. The fluorescence YL then passes the polarization separator 44 along the illumination optical axis Ax2 and enters the second retardation element RP. The wavelength converter 46 may be rotated by a rotator, such as a motor, around an axis of rotation parallel to the illumination optical axis Ax2.

The first retardation element 47 is disposed between the polarization separator 44 and the second light collector 48. The first retardation element 47 is a quarter wave plate that converts the blue light L2p having passed through the polarization separator 44 into circularly polarized blue light L2c. The blue light L2c enters the second light collector 48. The second light collector 48 causes the blue light L2c incident from the first retardation element 47 to converge and travel to the diffusive reflector 49. The second light collector 48 further parallelizes the blue light L2c incident from the diffusive reflector 49. The number of lenses that form the second light collector 48 can be changed as appropriate.

The diffusive reflector 49 diffusively reflects the blue light L2c incident thereon at the same angle of diffusion at which the fluorescence YL produced by and outputted from the wavelength converter 46 diffuses. The diffusive reflector 49 is, for example, formed of a reflector that reflects the blue light L2c incident thereon in the form of Lambertian reflection and a rotator that rotates the reflector around an axis of rotation parallel to the illumination optical axis Ax1.

The blue light L2c diffusively reflected off the diffusive reflector 49 passes through the second light collector 48 and enters the first retardation element 47. When reflected off the diffusive reflector 49, the blue light L2c is converted into right-handed circularly polarized light when the blue light L2c is left-handed circularly polarized light or vice versa. The blue light L2c having entered the first retardation element 47 via the second light collector 48 is therefore converted into s-polarized blue light L2s instead of the p-polarized blue light L2c having been incident on the first retardation element 47 via the polarization separator 44. The blue light L2s is then reflected off the polarization separator 44 and enters the second retardation element RP. According to the configuration described above, the light incident via the polarization separator 44 on the second retardation element RP is white light that is the combination of the blue light L2s and the fluorescence YL.

The second retardation element RP converts the white light incident via the polarization separator 44 into light that is the combination of the s-polarized component and the p-polarized component, that is, white illumination light WL. The illumination light WL exits toward the homogenizing apparatus 31 described above.

In the present embodiment, the configuration using semiconductor lasers as the light source 411 has been presented by way of example, but not necessarily. The light source of the projector 1 may instead, for example, be a light emitting diode or a discharge-type light source.

### 1.3 Detailed Arrangement of Dichroic Mirror and Other Components

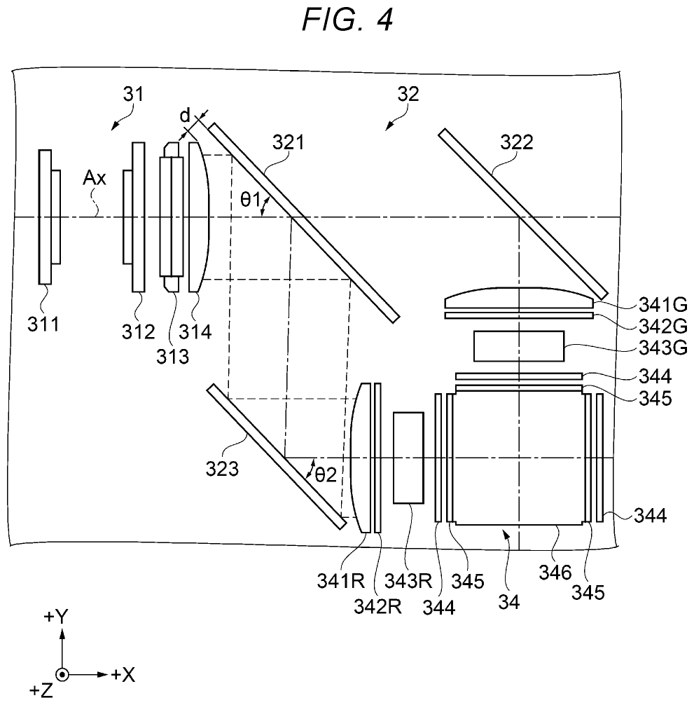

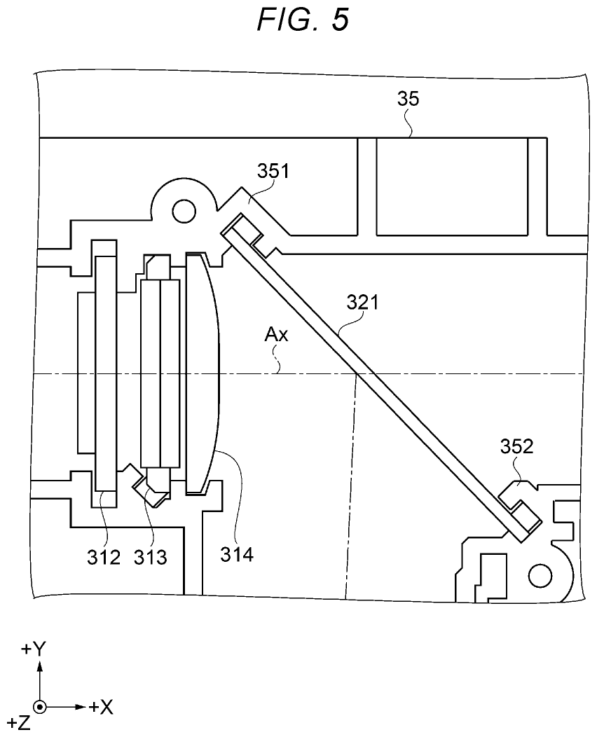

Detailed arrangement of the dichroic mirror 321, the superimposing lens 314, and other components will be described with reference to FIGS. 4 and 5. FIG. 4 is a diagrammatic view showing the detailed arrangement of the dichroic mirror, the superimposing lens, and other components. FIG. 5 is a plan view showing the arrangement of the dichroic mirror and fixing sections. FIG. 4 shows only the homogenizing apparatus 31, the color separation apparatus 32, and the image formation apparatus 34 and does not show the other components. FIG. 5 is an enlarged view of the area where the dichroic mirror 321 is disposed.

In FIGS. 4 and 5, axes X, Y, and Z are drawn as coordinate axes perpendicular to one another. The direction at which each arrow points is called a direction labeled with a + sign, and the direction opposite the direction labeled with the + sign is called a direction labeled with a − sign. A view viewed along the direction +Z is called a plan view, and the following description made with reference to FIGS. 4 and 5 relates to a state of the arrangement described above in the plan view unless otherwise specified. Further, the illumination optical axis Ax of the projector 1 is set along a plane substantially parallel to the plane X-Y and extends along the directions ±X at least between the homogenizing apparatus 31 and the dichroic mirror 321.

The homogenizing apparatus 31, the color separation apparatus 32, the image formation apparatus 34, and the relay apparatus 33 that is not shown are disposed in correspondence with the illumination optical axis Ax of the projector 1, as shown in FIG. 4. The illumination optical axis Ax passes through substantially the center of the homogenizing apparatus 31 and coincides with the optical axis of the homogenizing apparatus 31.

The dichroic mirror 321 is so disposed as to incline with respect to the optical axis of the superimposing lens 314, which is the illumination optical axis Ax. Specifically, the angle between the optical axis of the superimposing lens 314 and the light incident surface of the dichroic mirror 321 is el. The angle θ1 refers to the smaller one of the angles formed by the optical axis of the superimposing lens 314 and the light incident surface of the dichroic mirror 321. The angle θ1 is typically 45° in related art but is set at a value greater than 45° in the present disclosure. The angle θ1 is not limited to a specific value and may be any value greater than 45° and is 46° in the present embodiment. In the present embodiment, the light incident surface is a surface on which light, such as the illumination light, is incident, and a reflection surface is a surface that reflects light, such as the illumination light.

Setting the angle θ1 at a value greater than 45° allows the distance in the directions ±X required to place the superimposing lens 314 and the dichroic mirror 321 to be shortened as compared with a case where the angle θ1 is 45°. In detail, to maintain a shortest gap d between the superimposing lens 314 and the dichroic mirror 321, a larger angle θ1 allows the +X-direction-side end of the dichroic mirror 321 to be disposed in a position closer to the −X-direction side. In other words, the distance from the superimposing lens 314 to the +X-direction-side end of the dichroic mirror 321 can be shortened in the directions ±X. The size of the projector 1 can thus be reduced.

Consider a straight line passing through the center of the dichroic mirror 321 and extending along the directions ±Z as the angle of rotation, and the dichroic mirror 321 is so rotated around the axis of rotation that the angle θ1 is greater than 45°. In this case, the +X-direction-side end of the dichroic mirror 321 moves toward the −X-direction side, and the −X-direction-side end of the dichroic mirror 321 moves toward the +X-direction side. As a result, when the axis of rotation described above is placed in the same position as in the related art, the gap between the superimposing lens 314 and the dichroic mirror 321 increases. The increased gap can therefore be used to separately provide a mechanism that supports the dichroic mirror 321. As a result, the impact resistive strength of the dichroic mirror 321, for example, when the projector 1 falls, can be further improved.

Out of the illumination light having exited out of the superimposing lens 314, the red light reflected off the dichroic mirror 321 reaches the reflection mirror 323. The light incident surface of the dichroic mirror 321 and the reflection surface of the reflection mirror 323 are so disposed as to be substantially parallel to each other.

The red light described above is reflected off the reflection mirror 323 and enters the field lens 341R. The optical axis of the field lens 341R is substantially parallel to the optical axis of the superimposing lens 314 described above, which is the illumination optical axis Ax, in other words, the optical axis of the homogenizing apparatus 31. The angle θ2 between the optical axis of the field lens 341R and the reflection surface of the reflection mirror 323 is therefore substantially equal to the angle θ1. That is, the angle θ2 is greater than 45°. The angle θ2 is typically 45° in related art, as is the angle θ1.

In the present embodiment, the aforementioned illumination light outputted from the light source apparatus is a parallel light flux. Since the aforementioned illumination light is a parallel light flux, the illumination light flux is incident as a substantially parallel light flux on the dichroic mirror 321. Setting the angle θ1 at a value greater than 45° therefore still readily allows the light flux incident on the light modulator 343R to be a parallel light flux.

The optical enclosure 35 includes fixing sections 351 and 352, which hold and fix the dichroic mirror 321, as shown in FIG. 5. In detail, the dichroic mirror 321 has one end held by the fixing section 351 and the other end held by the fixing section 352 and is therefore fixed to the optical enclosure 35.

The fixing sections 351 and 352 are each a rib-shaped section that protrudes in the direction +Z from the optical enclosure 35, which has a substantially flat plate shape, and has a ±Z-direction height substantially equal to the height of the dichroic mirror 321. The fixing sections 351 and 352 each have a recess, and the dichroic mirror 321 is sandwiched and held between the recesses. In this configuration, the fixing sections 351 and 352 hold an area of the dichroic mirror 321 that is the area that is not illuminated with the illumination light having exited out of the superimposing lens 314. Shift of the dichroic mirror 321 primarily in a direction along a XY plane is therefore suppressed.

### 1.4 Configuration of Movable Section for Moving Reflection Mirror

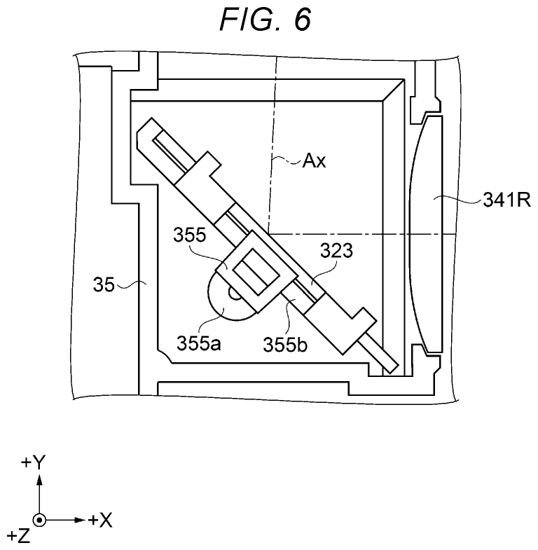

The configuration of a movable section with which the reflection mirror 323 is provided will be described with reference to FIG. 6. FIG. 6 is a plan view showing the exterior appearance of the movable section for moving the reflection mirror. FIG. 6 is an enlarged view showing an area where the reflection mirror 323 is disposed. The following description made with reference to FIG. 6 relates to a state of the reflection mirror 323 in the plan view.

The optical enclosure 35 is provided with a movable section 355, as shown in FIG. 6. The movable section 355 adjusts the orientation of the reflection surface of the reflection mirror 323 with respect to the optical axis of the field lens 341R. The movable section 355 includes a base section 355a fixed to the optical enclosure 35 and a holding section 355b, which holds the reflection mirror 323 and can be swung relative to the base section 355a. Specifically, fine adjustment is made on the orientation of the holding section 355b in a direction including at least any of the directions ±X, ±Y, and ±Z with respect to the base section 355a.

The optical axis of the reflection mirror 323 and the optical axis of the field lens 341R can thus be aligned with each other. That is, the red light reflected off the reflection mirror 323 can be readily aligned with respect to the optical axis of the field lens 341R. The projector 1 does not necessarily employ the configuration including the movable section 355.

As described above, the projector 1 according to the embodiment can provide the following effects.

The size of the projector 1 can be reduced. In detail, the dichroic mirror 321 in the color separation apparatus 32 is closest to the homogenizing apparatus 31 among those that form the color separation apparatus 32, in particular, the dichroic mirror 321 is so disposed as to be adjacent to the superimposing lens 314. The angle θ1 between the optical axis of the superimposing lens 314 and the dichroic mirror 321 is greater than 45°, which is a typical value. The superimposing lens 314 and the dichroic mirror 321 can therefore be so disposed as to be close to each other when the angle θ1 is smaller than or equal to 45°. The size of the projector 1 can thus be reduced in the directions ±X along the optical axis of the superimposing lens 314.

Since the fixing sections 351 and 352 fix the dichroic mirror 321, it is unnecessary to provide an adjustment margin for variable arrangement of the dichroic mirror 321, unlike the case where the dichroic mirror 321 can be variably arranged, whereby a space where the superimposing lens 314 and the dichroic mirror 321 are disposed can be further reduced. This allows a projector 1 that can be more readily reduced in size than in related art to be provided.

Since the dichroic mirror 321 and the reflection mirror 323 are so disposed as to be substantially parallel to each other, the red light reflected off the dichroic mirror 321 can be reflected off the reflection mirror 323 with substantially the same light flux diameter of the red light maintained.

Since the reflection mirror 323 is provided with the movable section 355, the red light is reflected off the reflection mirror 323 and can enter the field lens 341R with the red light aligned with the field lens 341R.

Since the projector 1 includes the dichroic mirrors 321 and 322, the illumination light having exited out of the homogenizing apparatus 31 can be separated into three light fluxes, red light, green light, and blue light, for the following use.

Since the projector 1 includes the light modulators 343R, 343G, and 343B and the color combining apparatus 346, the modulated light fluxes modulated by the three-plate-type light modulators can be combined with one another. A compact three-plate-type projector 1 can therefore be achieved.

The contents derived from the embodiment will be described below.

A projection-type display apparatus includes a light source apparatus, a first optical system that includes a superimposing lens and that illumination light outputted from the light source apparatus enters, a second optical system including a first color separator, a mirror, and a field lens, and an optical enclosure that accommodates the second optical system. The first color separator is disposed on the downstream of the superimposing lens, reflects first light that is contained in the illumination light that exits out of the first optical system and belongs to a first wavelength band toward the mirror, and transmits light that belongs to a wavelength band excluding the first wavelength band. The mirror reflects the first light reflected off the first color separator toward the field lens. The angle between the optical axis of the superimposing lens and the first color separator is greater than 45° in the plan view of the first optical system. The optical axis of the field lens is substantially parallel to the optical axis of the first optical system. The optical enclosure includes a fixing section that holds and fixes the first color separator.

According to the configuration described above, the size of the projection-type display apparatus can be reduced. In detail, the first color separator in the second optical system is closest to the first optical system among those that form the second optical system, in particular, the first color separator is so disposed as to be adjacent to the superimposing lens. The angle between the optical axis of the superimposing lens and the first color separator is greater than 45°, which is a typical value. The superimposing lens and the first color separator can therefore be so disposed as to be close to each other when the angle described above is smaller than or equal to 45°. The size of the projection-type display apparatus can thus be reduced in the direction along the optical axis of the superimposing lens.

Since the fixing section fixes the first color separator, it is unnecessary to provide an adjustment margin for variable arrangement of the first color separator, unlike the case where the first color separator can be variably arranged, whereby a space where the superimposing lens and the first color separator are disposed can be further reduced. This allows a projection-type display apparatus that can be more readily reduced in size than in related art to be provided.

In the projection-type display apparatus described above, the first color separator and the mirror may be so disposed as to be substantially parallel to each other.

According to the configuration described above, the first light reflected off the mirror is allowed to enter the field lens with the first light substantially parallel to the optical axis of the first optical system.

The projection-type display apparatus described above may include a movable section that adjusts the orientation of the mirror with respect to the optical axis of the field lens.

According to the configuration described above, the first light is reflected off the mirror and can enter the field lens with the first light aligned with the field lens.

In the projection-type display apparatus described above, the second optical system may include a second color separator that, out of the light that belongs to a wavelength band excluding the first wavelength band, reflects second light that belongs to a second wavelength band, and transmits third light that belongs to a wavelength band excluding the second wavelength band.

According to the configuration described above, the illumination light having exited out of the first optical system can be separated into three light fluxes, the first light, the second light, and the third light, which belong to different wavelength bands, for the following use.

The projection-type display apparatus described above may include a first light modulator that modulates the first light, a second light modulator that modulates the second light, a third light modulator that modulates the third light, and a color combiner that combines the modulated color light fluxes with one another.

According to the configuration described above, the modulated light fluxes modulated by what is called three-plate-type light modulators including the first, second, and third light modulators can be combined with one another. A compact three-plate-type projection-type display apparatus can therefore be achieved.

What is claimed is:

1. A projection-type display apparatus comprising:
a light source apparatus;
a first optical system that includes a superimposing lens and that illumination light outputted from the light source apparatus enters;
a second optical system including a first color separator, a mirror, and a field lens; and
an optical enclosure that accommodates the second optical system,
wherein the first color separator is disposed on a downstream of the superimposing lens,
the first color separator reflects, toward the mirror, first light that is contained in the illumination light and that belongs to a first wavelength band, and transmits light that belongs to a wavelength band excluding the first wavelength band,
the mirror reflects, toward the field lens, the first light reflected by the first color separator,
an angle between an optical axis of the superimposing lens and the first color separator is greater than 45° in a plan view of the first optical system,
an optical axis of the field lens is substantially parallel to an optical axis of the first optical system, and
the optical enclosure includes a fixing section that holds and fixes the first color separator.

2. The projection-type display apparatus according to claim 1, wherein the first color separator and the mirror are so disposed as to be substantially parallel to each other.

3. The projection-type display apparatus according to claim 1, further comprising a movable section that adjusts orientation of the mirror with respect to the optical axis of the field lens.

4. The projection-type display apparatus according to claim 1, wherein the second optical system includes a second color separator that, out of the light that belongs to a wavelength band excluding the first wavelength band, reflects second light that belongs to a second wavelength band, and transmits third light that belongs to a wavelength band excluding the second wavelength band.

5. The projection-type display apparatus according to claim 4, further comprising a first modulator that modulates the first light, a second modulator that modulates the second light, a third modulator that modulates the third light, and a color combiner that combines lights which are respectively modulated by the first modulator, the second modulator, and the third modulator.
